(19) United States
(12) Patent Application Publication
(10) Pub. No.: US 2008/0088124 A1
(43) Pub. Date: Apr. 17, 2008

(54) MICROGRAPHIC DEVICE

(76) Inventors: Robert Arthur LEE, East Burwood (AU); Graham Louis QUINT, Preston (AU); Mervyn Charles Kimm, (US)

Correspondence Address: LADAS & PARRY LLP, 224 SOUTH MICHIGAN AVENUE, SUITE 1600, CHICAGO, IL, 60604, US

(21) Appl. No.: 11/691,761

(22) Filed: Mar. 27, 2007

Related U.S. Application Data
(63) Continuation-in-part of application No. 09/509,649, filed on Mar. 30, 2000, now abandoned.

(30) Foreign Application Priority Data
Oct. 2, 1997 (AU) PO 9572

(51) Int. Cl. B42D 15/00

(52) U.S. Cl. 283/72

(57) ABSTRACT

A security device including a surface relief structure having a plurality of regions. The plurality of regions includes gray scale regions which together form a macroscopic gray scale image when illuminated by incident light and viewed by an observer. Each gray scale region has at least one dimension smaller that 0.25 mm. Each gray scale region includes a plurality of scattering centres for scattering incident light, each scattering centre including one or more surface relief structure elements. Each gray scale region has a gray scale value determined by the degree of scattering caused by the scattering centres and surface relief structure elements.

### FIELD OF THE INVENTION

This invention relates to a micrographic device. It relates particularly but not exclusively to a security device which generates a gray scale image when illuminated by a light source and viewed by an observer, and to an authentication device which incorporates graphic elements line art or images represented in microscopic size in repeated regions of its surface relief structure. The device may be used in a number of different applications, and it has particular applicability as an anti-forgery security device on bank notes, credit cards, cheques, share certificates and other similar documents.

### BACKGROUND ART

Recent improvements in reproduction technology have made it easier for a person to forge a copy of a valuable document. Various different types of security devices are available to protect against copying. One such type of security device is a hologram of the type which has been applied to VISA ™ and MasterCard™ credit cards since 1984. When viewed under appropriate illumination conditions (best seen with a point light source such as a single incandescent globe), holograms generate an image which appears to change as the angle of observation changes. When not illuminated, the hologram as a silver appearance. Holograms provide protection against colour photocopying and similar reproductive techniques because such reproductive techniques cannot reproduce the ability to generate images which differ when viewed from different angles.

Holograms are a member of a class of security devices referred to as optically variable devices (OVDs). Newer and more secure optically variable devices have been developed, including dot matrix hologram technology (EPO 467 601 A2), KINEGRAM™ technology (EP105099, EP330738, EP375833) as first used on the Saudi Arabia passport in 1987 and later on the Austrian 5000 Schilling bank note in 1990, CATPIX™ grating technology (PCT/AU89/00542) used on the Australian plastic ten dollar bank note issued in 1988 and the Singapore plastic 50 dollar bank note in 1990, PIXELGRAM™ diffraction technology (PCT/AU90/00395, U.S. Pat. No. 5,428,479) and EXELGRAM™ diffraction technology (PCT/AU94/00441) which appeared on Australian opal stamps and Vietnam bank cheques issued in 1995 and on AMEX™ travellers cheques and Hungarian bank notes in 1997.

The contents of International patent applications PCT/AU90/00395 and PCT/AU94/00441, both in the name of the present applicant, are hereby incorporated herein by reference.

OVDs typically consist of a thin layer of a metallised foil applied by means of an adhesive to a substrate. A typical OVD appears silver in colour, and this can adversely affect the contrast in images viewed by an observer.

Rough treatment of a document bearing an OVD can result in substantial diminution in the optically variable effects produced by the OVD, with a resulting reduction in the degree of security afforded.

Most OVDs can be simulated to some extent by holographic copying techniques. While holographic copying equipment is not as readily available as colour photocopiers, the technology is available to the determined forger. Simulations made using holographic copying typically do not incorporate all of the security features of original OVDs, and they typically have a lower quality, but they are often of sufficient quality to mislead unsuspecting members of the public. It is therefore desirable for security devices copied by holographic techniques to be obviously different from the original.

It would be desirable to provide some improvements in security device technology.

### SUMMARY OF THE INVENTION

According to the present invention, there is provided a security device including a surface relief structure having a plurality of regions, the plurality of regions including gray scale regions which together form a macroscopic gray scale image when illuminated by incident light and viewed by an observer,

each gray scale region having at least one dimension smaller that 0.25 mm,

wherein each gray scale region includes a plurality of scattering centres for scattering incident light, each scattering centre including one or more surface relief structure elements, and

wherein each gray scale region has a gray scale value determined by the degree of scattering caused by the scattering centres and surface relief structure elements This allows the device to simulate an optically invariable “printed” appearance, which is not capable of being copied by holographic techniques.

Preferably, each gray scale region is of size 120 micron by 120 micron or less.

In one or more embodiments, the scattering centres and surface relief structure elements of each gray scale region form one or more recognisable images. The one or more recognisable images formed by the scattering centres and surface relief structure elements of at least one gray scale region may be different from the one or more recognisable images formed by the scattering centres and surface relief structure elements of at least another gray scale region.

Alternately, the one or more recognisable images formed by the scattering centres and surface relief structure elements of at least one gray scale region may be the same as the one or more recognisable images formed by the scattering centres and surface relief structure elements of at least another gray scale region. The plurality of regions are arranged in a regular array.

The particular shade of brown or grey generated by a light scattering region is dependent upon the number of scattering centres and feature sizes of those scattering centres within a given surface area.

The particular resolution of the “printed” appearance depends upon the size of each scattering region. It is preferred although not necessary that the regions be too small to be separately discernible to the unassisted human eye. It is preferred that each region is of size 120 micron by 120 micron or less.

It is preferred that the device include both diffractive surface relief structure regions and scattering regions, so that, under appropriate illumination conditions, both optically variable effects and “printed”-type effects can be seen by the observer.

Where the device is a foil applied to the surface of a valuable document such as a bank note, the “printed” effects caused by the scattering regions can be made to line up with and complement the printed effects such as guilloche effects on the rest of the valuable document that is, the printing on the valuable document can be made to match up with and appear to be continuous with regions on the device which have a printed appearance. This gives the device a more integrated appearance with the rest of the document, rather than the separate “appended” appearance of a typical OVD.

As a preferred feature, one or more of the gray scale region structure types may have one or more graphic elements, line art or images represented in microscopic size in their surface relief structures. This results in multiple replication of the graphic elements line art or images across the device, making it impossible to destroy all copies by reason of rough usage.

In this preferred form, the same image may be represented in each gray scale region structure type, but with differing diffuse scattering characteristics. Alternatively, different graphic elements, line art or images may be represented in the different gray scale region structure types.

In some embodiments, each micrographic region may have an identical image represented in its surface relief structure. In other embodiments, each micrographic region may have a structure which is one of a limited number of micrographic region structure types.

Some embodiments may be constructed in such a way that, when the device is illuminated by a light source and viewed by an observer, the observer sees in macroscopic form an image which corresponds with a microscopic image represented in the surface relief structure of some or all of the regions.

It is preferred that the device also be an optically variable device.

In a preferred form, the device includes a plurality of diffracting regions such that, upon illumination by a light source, the device generates one or more diffraction images which are observable from one or more ranges of viewing angles around the device. Non-diffracting regions may provide a contrast enhancing dark background to the diffraction image or images. Alternatively, non-diffracting regions may provide gray scale enhancements to the diffraction image or images.

In some embodiments, some or all of the regions may be hybrid regions which include both periodic surface structure which has diffractive effects and graphic elements, line art or images which have diffuse scattering effects.

In some embodiments, regular arrays of alpha numeric characters or similar size graphics can be used to generate an optical effect which includes both diffractive and diffuse scattering components.

Microscopic text may be embossed onto or engraved into the tops of diffractive periodic surface structure elements and/or between diffractive periodic surface structure elements, in order to give an additional authentication feature.

The inventive device is particularly useful for authentication purposes. Authentication of the device may take place by microscopic examination and recognition of the regions. Alternatively, authentication of the device may take place by machine recognition of the regions.

### BRIEF DESCRIPTION OF THE DRAWINGS

The invention will hereafter be described in greater detail with reference to the attached drawings which show example forms of the invention. It is to be understood that the particularity of those drawings does not supersede the generality of the preceding description of the invention.

FIG. 1 is a schematic diagram illustrating the operation of the invention.

FIG. 2 is a sample line art image which, when applied in microscopic format to the surface relief structure of a device creates a suitable region for use in accordance with the invention.

FIG. 3 shows the trapezoidal shapes used to generate the image of FIG. 2.

FIG. 4 shows some numerals which are suitable for use in the same manner.

FIG. 5 shows some graphics which are suitable for use in the same manner.

FIG. 6 shows the rectangular shapes used to generate the image of FIG. 5.

FIG. 7 shows some graphics which are suitable for use in the same manner.

FIG. 8 shows some writing which is suitable for use in the same manner.

FIG. 9 is a representation of a sample macroscopical image for use in a security device.

FIGS. 10 and 11 are representations of exemplary gray scale regions used to compose the macroscopic image shown in FIG. 9.

### DETAILED DESCRIPTION OF THE DRAWINGS

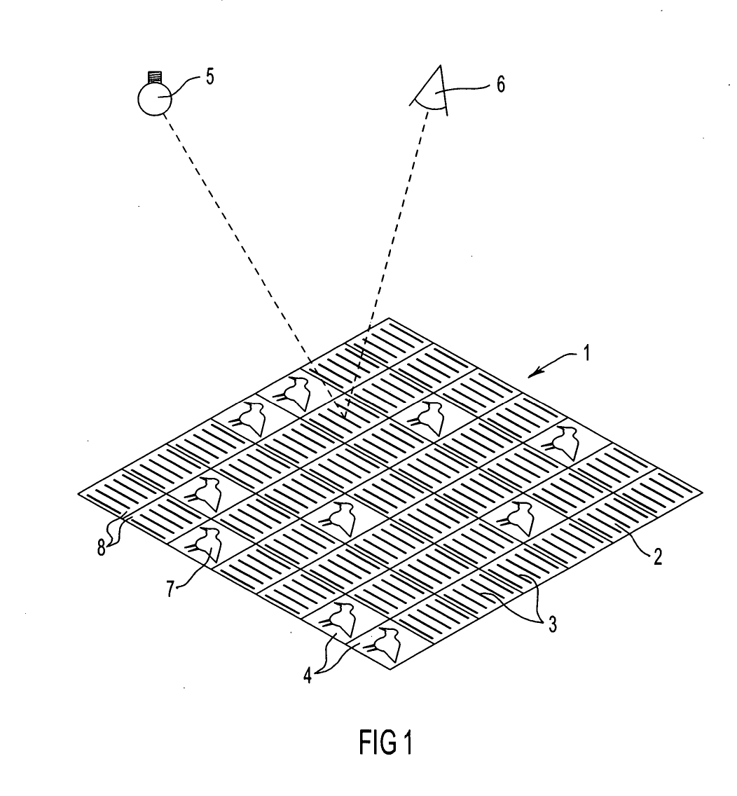

Referring now to FIG. 1, there is shown device 1 having surface relief structure 2 which has a plurality of regions 3. Regions 3 include gray scale regions 4, which are too small to be separately resolvable to the human eye. (They are shown in much magnified state in FIG. 1). Each gray scale region 4 is one of a limited number of different gray scale region structure types. The different gray scale region structure types appear, by reason of their differing diffuse scattering characteristics, to have different intensities when device 1 is illuminated by light source 5 and viewed by an observer 6.

The gray scale region structure types may be developed by selecting a limited number of diffuse scattering structures, each of which has different scattering characteristics. A diffuse scattering structure may be created randomly. However, most graphic elements, line art drawings and images naturally possess diffuse scattering characteristics, and it is a preferred feature of the present invention that the diffuse scattering regions use relief structures which incorporate graphic elements such as alpha numeric characters or recognisable shapes, line art drawings, or other images. The use of such recognisable images in the diffuse scattering regions adds to the security of the device in that of authenticity of the device can be checked by microscopic examination of the diffuse scattering regions.

Although a single image has predetermined scattering characteristics, and hence a predetermined gray scale intensity value, the diffusion characteristics and gray scale value can be altered by altering such features as depth of the surface relief structure, sharpness of the surface relief structure profile, and introduction or removal of random “noise” structures by varying the number of scattering centres and feature sizes of the scattering centres within the region. It is therefore possible to use the same image to generate all of the different gray scale region structure types.

It is of course not necessary to use the same image in each gray scale region, and different gray scale region structure types may use different images.

As stated above, the gray scale regions are too small to be separately resolvable to the human eye. For a normal human eye, the smallest resolvable structure has a width of about 0.25 mm. Any size below this is suitable, although the presently preferred size is a region approximately 30 micron×30 micron. It is not necessary that the region be square; it may be hexagonal, circular, or any other suitable shape. In International Application PCT/AU94/00441 there is extensive discussion concerning the merits of using long narrow strips, rather than small squares. It is also possible for the surface relief structure to be substantially continuous, so that there is no clearly discernible separation between notional adjoining surface regions.

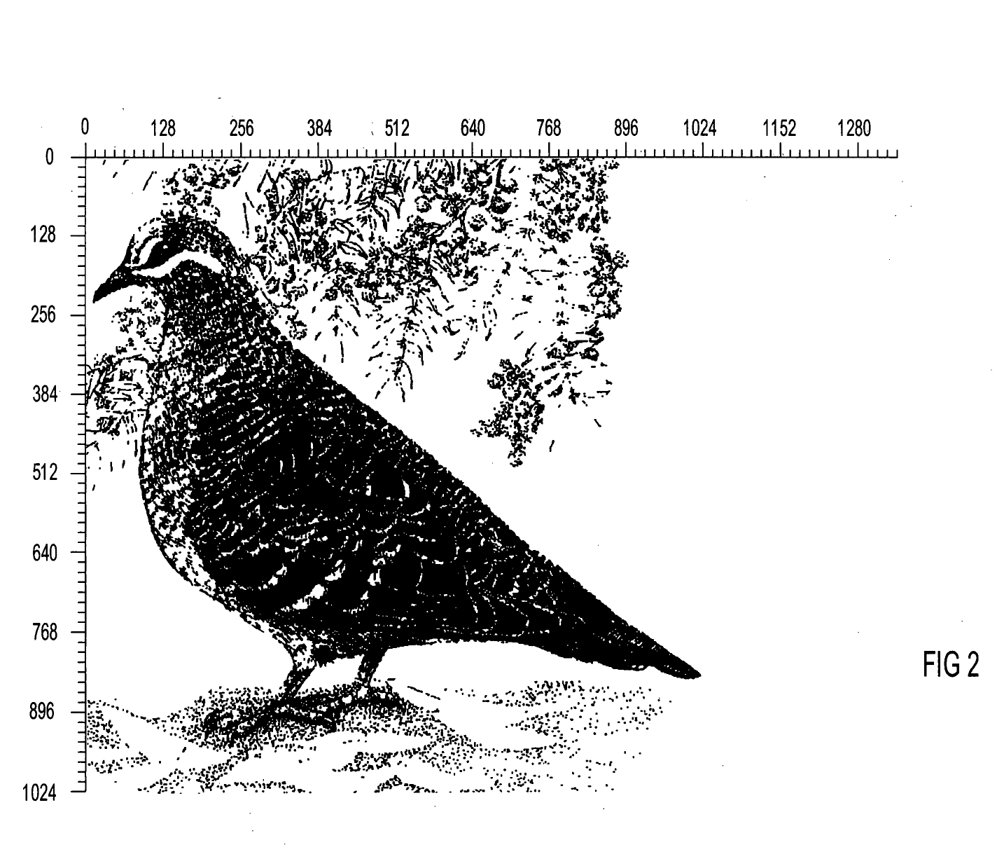

In a special case of the present invention, the microscopic image produced by the device upon illumination may be the same image as the microscopic image which is represented in the surface relief structure of some or all of the regions. By way of example, FIG. 2 shows a pigeon comprised of approximately 1,024×1,024 pixels. In an electron beam writing device operating at a high resolution, this corresponds with a surface region of approximately 30 micron×30 micron. In a macroscopic image generated by light illuminating a surface relief structure into which the microscopic pigeon shape has been embossed, the pigeon shape will be responsible for one tiny dark dot. When the pigeon shape has been embossed into a large number of different areas of the surface relief structure corresponding with the macroscopic shape of the pigeon, wherein each embossing represents a single pixel of the macroscopic image, the result after illumination will be a macroscopic image of the pigeon. This is of course a special case, and the dark image dots created by individual pigeon shape embossing can be used to create any desired macroscopic image.

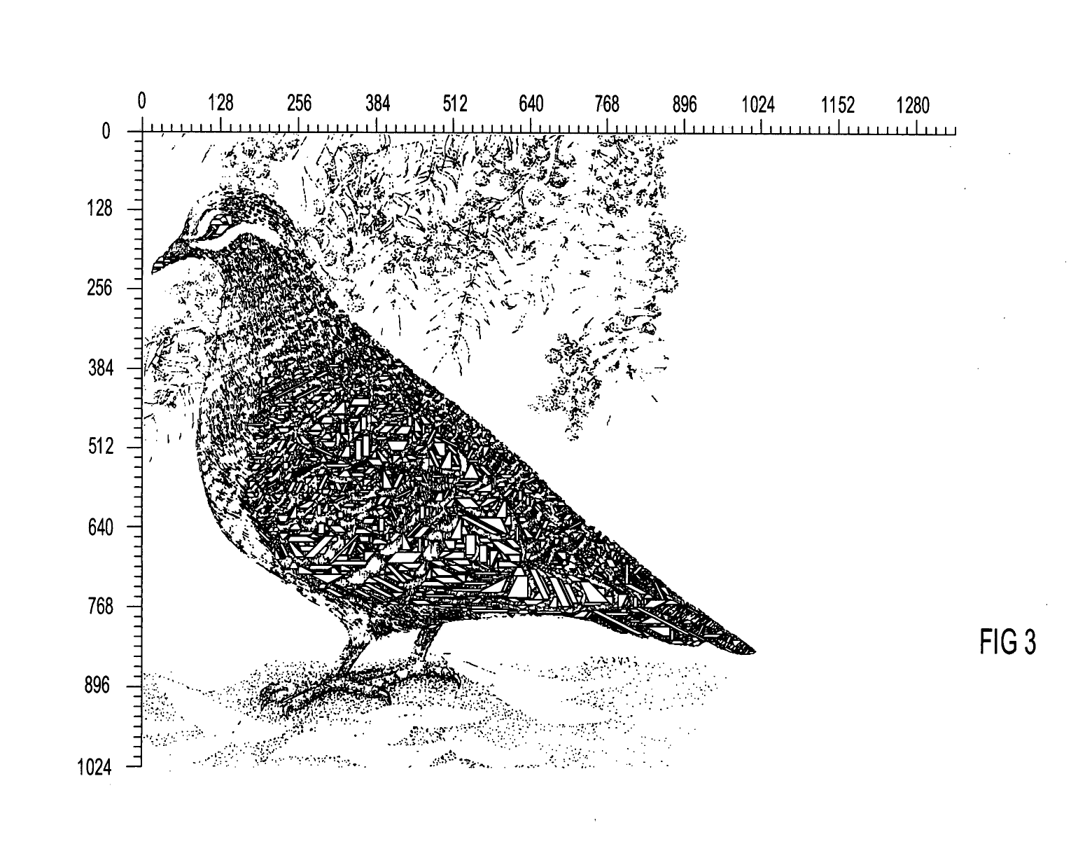

The image shown in FIG. 2 began as a line art image. The line art image was converted by a mathematical conversion process into a group of geometrical figures, as shown in FIG. 3, to facilitate engraving by the electron beam lithography process. The engraving process results in the image of FIG. 2.

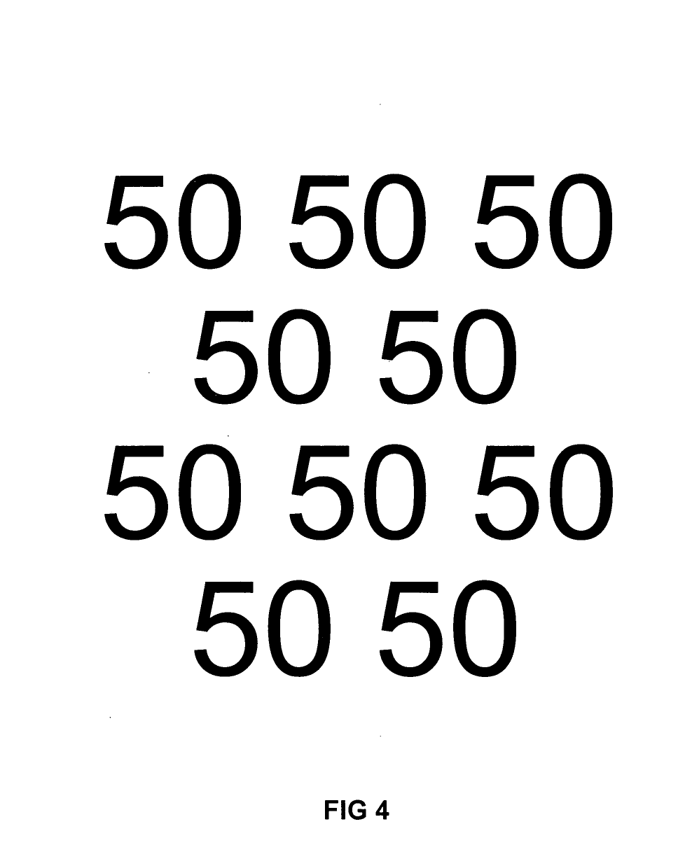

The graphics in FIG. 4 consist of the numerals “50” arranged in a pattern, with the total pattern being of suitable resolution for transfer by electron beam lithography process onto a surface region of approximately 30 micron×30 micron in size.

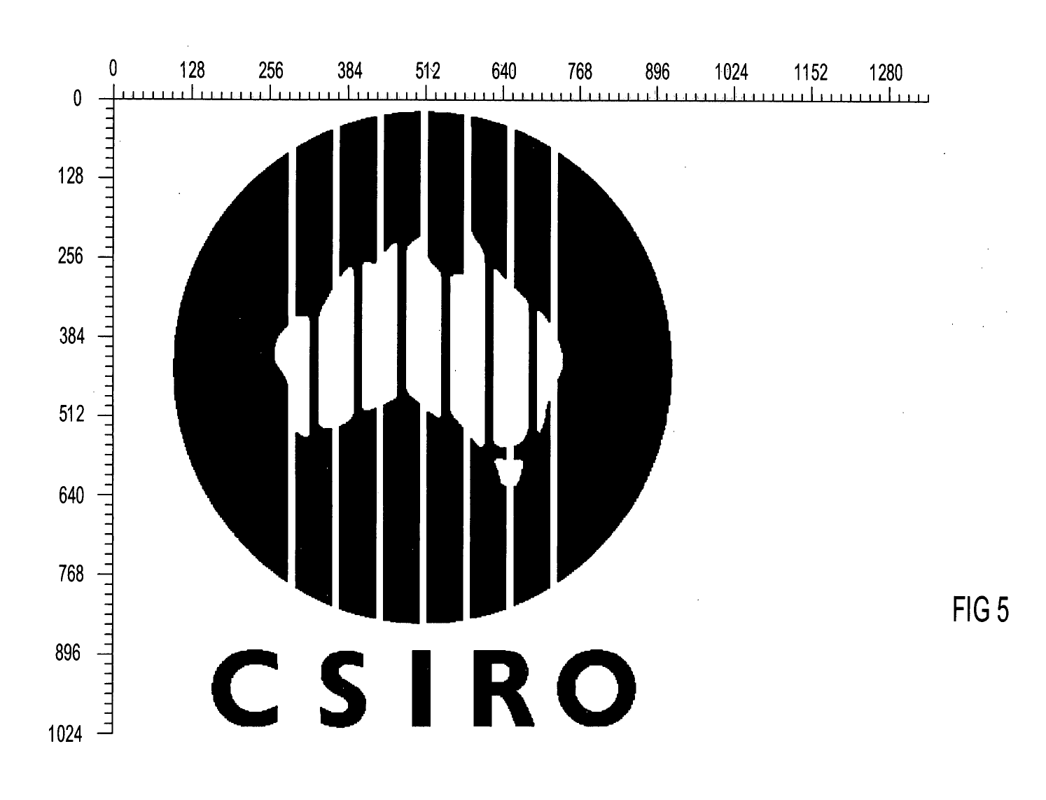

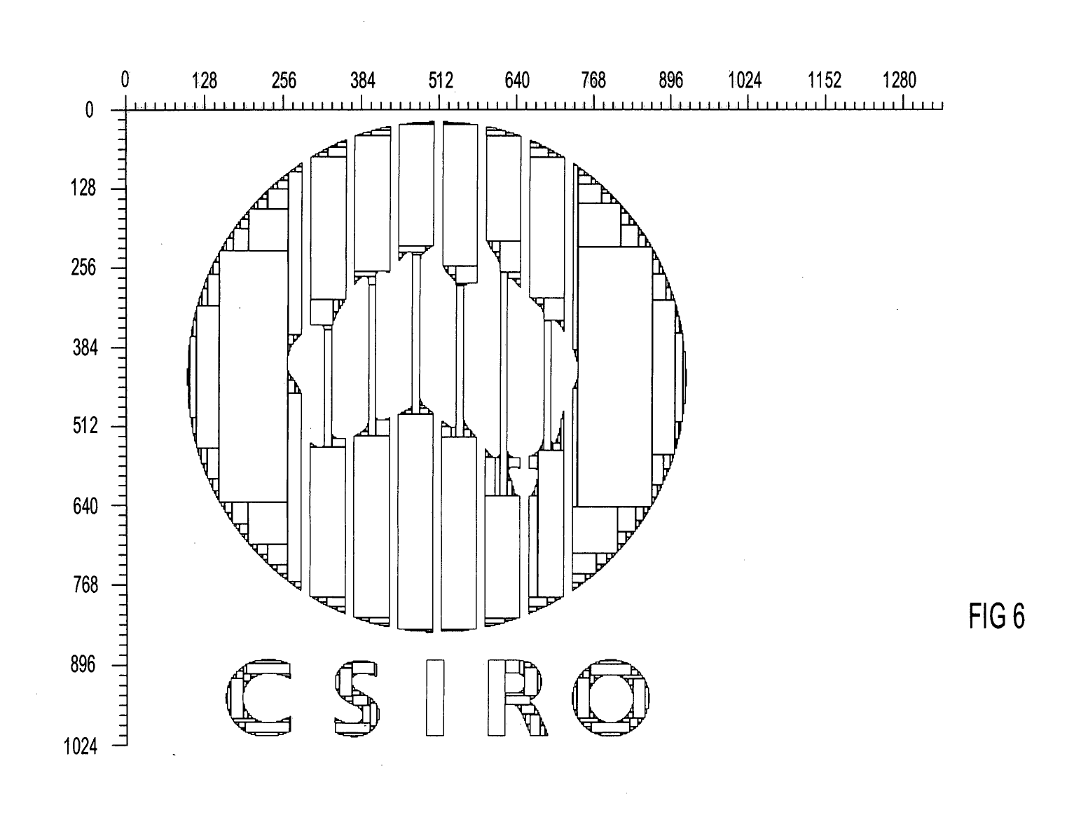

FIG. 5 shows some more graphics comprised of the alphabetic letters CSIRO, and the logo of the Commonwealth Scientific and Industrial Research Organisation. This art work also began as line art, which was converted into a pattern of rectangles as shown in FIG. 6, to facilitate transfer by the electron beam lithography process to a surface relief structure region approximately 30 micron×30 micron in size, resulting in the structure of FIG. 5.

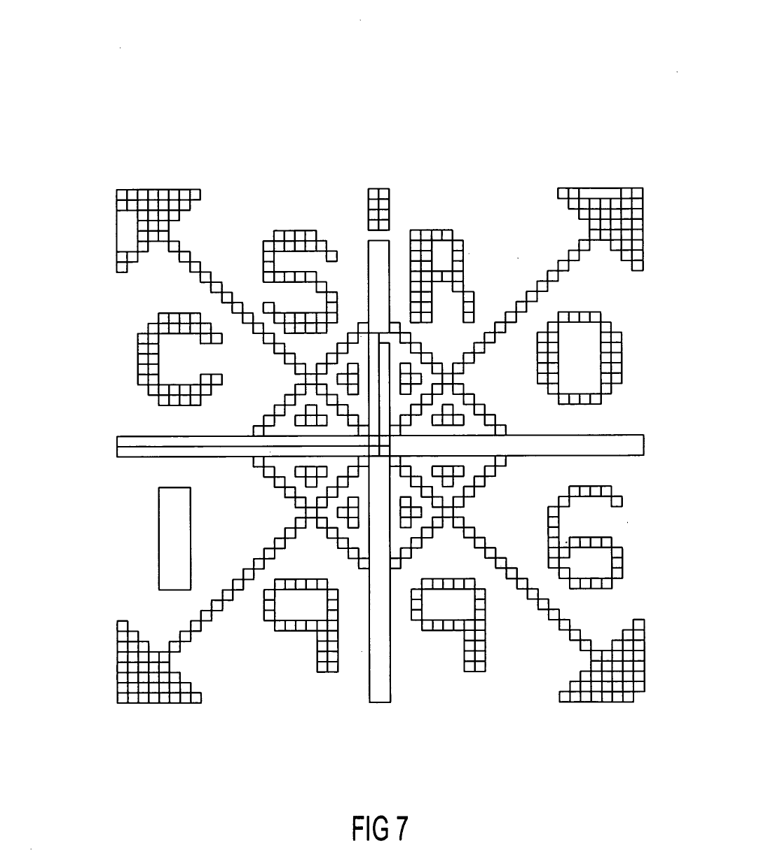

FIG. 7 shows some more graphics comprised of alpha numeric symbols and other symbols and shapes, once again suitable for transfer by electron beam lithography to a surface region approximately 30 micron×30 micron in size.

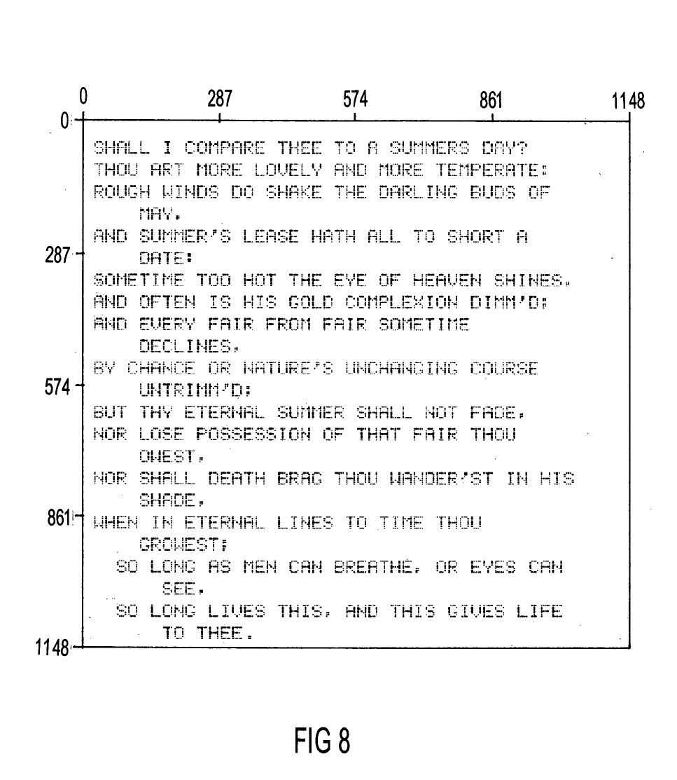

FIG. 8 shows one of Shakespeare's sonnets written in dot-matrix style letters within a square region. This text arrangement is suitable for transfer by electron beam lithography to a surface region approximately 30 micron by 30 micron in size.

Scattering is a general physical process whereby some forms of radiation, such as light, are forced to deviate from a straight trajectory by one or more localised non-uniformities in the medium upon which the radiation in incident. The types of non-uniformities that cause scattering, otherwise known as scatterers or scattering centres, are too numerous to list, but can include particles, bubbles, droplets, density fluctuations in fluids, defects in crystalline solids, surface roughness, cells in organisms and textile fibres in clothing. In the exemplary embodiment shown in FIG. 1, the scattering centres are composed of one or more surface relief structure elements.

Each gray scale region 4 includes a plurality of scattering centres. When scattering centres are grouped together, incident light is scattered many times by a process known as multiple or diffuse scattering. In this process, a large number of scattering events occur as light is scattered by the surface relief structure elements of the various scattering centres in each gray scale region 4. The degree to which incident light is scattered by the scattering centres and their component surface relief structure elements determines the relative darkness or lightness—and hence the gray scale value—each gray scale region 4.

The degree of scattering varies as a function of the characteristics of the scattering centres and their surface relief structure elements. These characteristics include notably the number and location of the scattering centres within each gray scale region, the depth of the surface relief structure elements, the “sharpness” or peak width of surface relief structure elements, and the shape and size of the surface relief structure elements. It should be understood though that this list of characteristics is non-exhaustive.

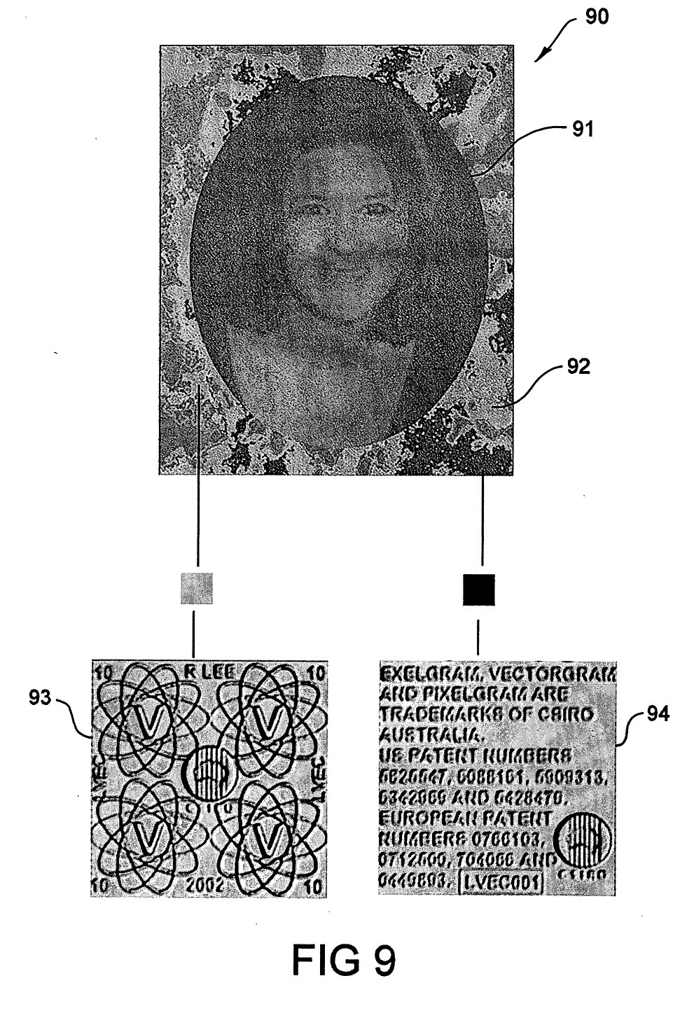

FIG. 9 shows an example of a macroscopic image 90 of a portrait of a woman in a central elliptical area 91 surrounded by a mottled border area 92. The macroscopic image is formed by a plurality of gray scale regions each having predetermined gray scale value. The dimensions of the macroscopic image are 20.01 mm×24.57 mm. Two exemplary gray scale regions 93 and 94 forming part of the macroscopic image 90 are illustrated in this Figure. The scattering centres and relief surface structure elements of the gray scale region 93 result in a higher degree of scattering that the scattering centres and relief surface structure elements of the gray scale region 94, and hence the gray scale region 93 has a lower grey scale (i.e. appears lighter) that the gray scale region 94. Each gray scale region has dimensions of 30 μm×30 μm. The height of the surface relief structure elements in each gray scale region are in the order of 0.3 μm to 0.4 μm.

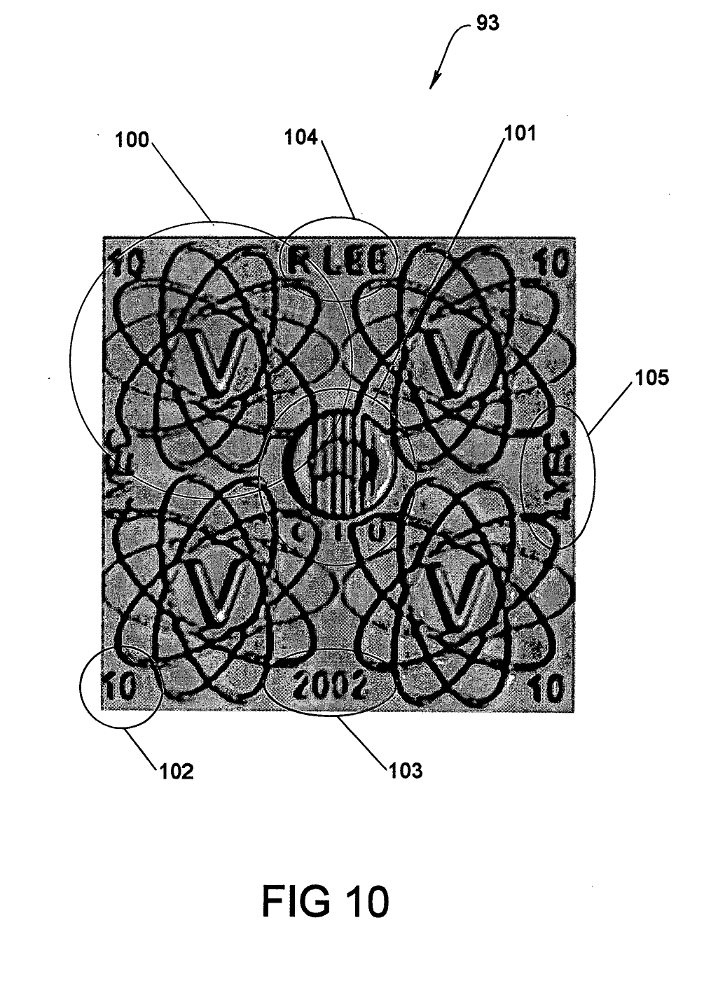

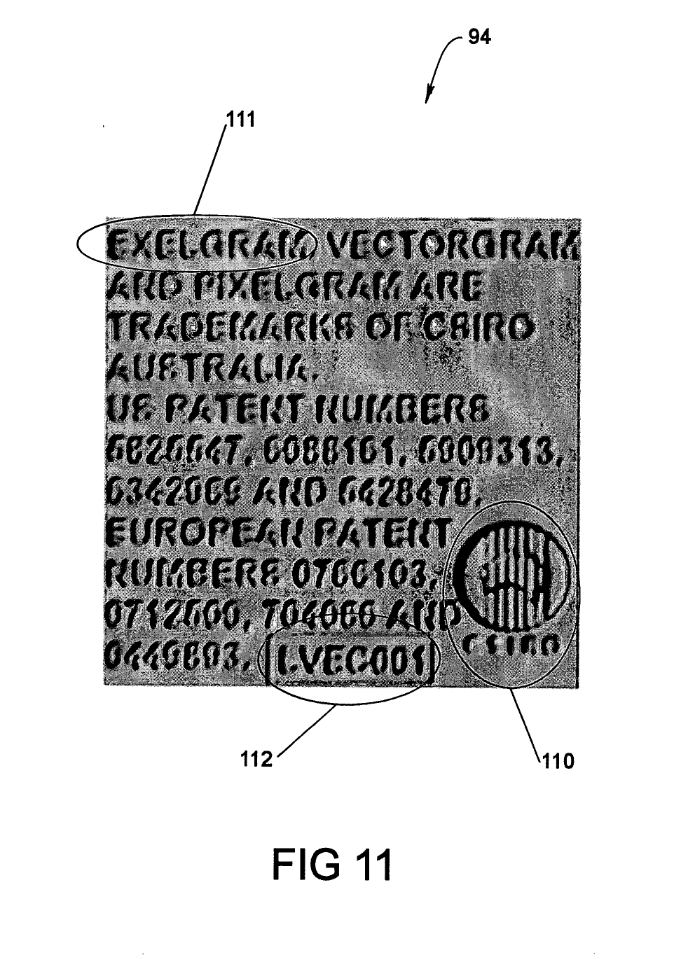

FIGS. 10 and 11 respectively show the gray scale regions 93 and 94 in more detail. From FIG. 10 it can be seen that the gray scale region 93 includes a number of different types of scattering centres. A first type of scattering centre 100 includes surface relief structure elements in the shape of the letter “V” superposed with the atomic symbol (a series of ellipses). This type of scattering centre is repeated four times in the gray scale region 93. A second type of scattering centre 101 includes surface relief structure elements corresponding to the letters and logo shown in FIG. 5, and is located centrally in the gray scale region 93. A third type of scattering centre 102 includes surface relief structure elements corresponding to the number “10”, and is located in each of the four corners of the gray scale region 93. A fourth type of scattering centre 103 includes surface relief structure elements corresponding to the number “2002”, and is located along one edge of the gray scale region 93. A fifth type of scattering centre 104 includes surface relief structure elements corresponding to the letters “R LEE”, and is located along another edge of the gray scale region 93. A sixth type of scattering centre 105 includes surface relief structure elements corresponding to the letters “LVEC”, and is located along two edges of the gray scale region 93.

The gray scale region 94 shown in FIG. 11 also includes a number of different types of scattering centres. A first type of scattering centre 110 includes surface relief structure elements corresponding to the letters and logo shown in FIG. 5, and is located in one corner of the gray scale region 94. A second type of scattering centre 111 includes surface relief structure elements corresponding to a series of alphanumeric characters, and is repeated across substantially the whole the gray scale region 94. A third type of scattering centre 112 includes surface relief structure elements in the form of the alphanumeric characters “LVEC001” inside a rectangle. This scattering centre is located along one edge of the gray scale region 94.

It should be understood that the scattering centres and their component surface relief structure elements forming gray scale regions 93 and 94 are merely two possible implementations of gray scale regions suitable for use in forming the exemplary macroscopic image 90 shown in FIG. 9.

When the ratio of the width of the surface relief structure elements to the wavelength of the incident light is greater than about 10, the interaction between the incident light and the surface relief structure elements is not usually described as scattering. In the example of visible light which has a wavelength that ranges from 380 nm to 780 nm, the width of the surface relief structure elements forming the scattering centres should therefore generally be no greater than around 10 μm.

Device 1, in addition to gray scale regions 4, may include a plurality of diffracting regions 8, such that, upon illumination by light source 5, device 1 generates one or more diffraction images which are observable from one or more ranges of viewing angles 6 around the device. With this preferred feature, the device acts as an optically variable device with the additional benefits of the present invention. The non-diffracting regions, which may include some or all of the gray scale regions 4 may provide a contrast-enhancing dark backgrounds to the diffraction image or images. As indicated previously, optically variable devices typically have a silver background, which may detract from the contrast of the diffraction image generated. The use of diffusely scattering regions 4 results in a dark background, which enhances image contrast.

The diffracting regions 8 may be formed from diffraction gratings. A diffraction grating is a light reflecting element whose optical properties are periodically modulated. The diffraction gratings may be realised as fine parallel and equally spaced grooves or lines formed in the surface relief structure 2. Diffraction gratings are usually characterised by their groove density, namely the number of grooves per unit length, which is the inverse of the “groove period”. For a diffracting effect to occur, the groove period must be of the same order of magnitude as the wavelength of the light incident upon the diffraction grating. In the optical regime, this corresponds to wavelengths (and groove spacings) of between 100 nm and 10 μm.

Further or alternatively, gray scale regions 4 may provide a gray scale enhancement to the diffraction image or images. This may be by way of highlights, enhancements, an integral part of image, or a super imposed image.

The above description has proceeded on the assumption that diffracting surface regions are separate from diffusely scattering surface regions. However, it is possible that a single surface region may include both diffuse scattering and diffractive effects. A single region may be a hybrid region which includes both periodic surface structure, which has diffractive effects, and graphic elements, line art or images which have diffuse scattering effects.

It is also possible to use regular arrays of alpha numeric characters or similar symbols to generate an optical effect which includes both diffractive and diffuse scattering components.

Micrographic surface structure regions according to the invention have a number of different practical applications including the following:

1. They can be used as an additional level security feature which can be checked using high speed microscopic machine vision systems.

2. The non-periodic structure of the micrographic regions means that holographic or contact copying of the structures is impossible to achieve.

3. Because diffusely scattering micrographic regions are impossible to copy holographically, the differences in gray scale level of the micrographic gray scale elements become indistinguishable on a copied device and therefore any macroscopic graphic feature constructed out of at least two types of micrographic regions will be unobservable on the copied device.

4. Micrographic regions can therefore be used as a unique background optically invariable security feature on diffractive images originated using electron beam lithography techniques.

5. Because individual micrographic surface structures appear many hundreds or even thousands of times as a background to the diffractive features of an OVD, the micrographic information possesses multiple redundancy and is available for microscopic identification and authentication purposes even after severe scratching of the OVD foil.

6. Micrographic regions can be used as a contrast enhancing dark background to the diffractive features of an OVD so that the apparent brightness of the diffractive features is increased.

7. Micrographic regions can be used to make OVDs appear far less metallic than normal metallised foil. The diffuse scattering effect of the micrographic regions is the source mechanism for this result.

It is to be understood that various alterations additions and/or modifications may be made to the parts previously described without departing from the ambit of the invention.

1. A security device including a surface relief structure having a plurality of regions, the plurality of regions including gray scale regions which together form a macroscopic gray scale image when illuminated by incident light and viewed by an observer, each gray scale region having at least one dimension smaller that 0.25 mm,
wherein each gray scale region includes a plurality of scattering centres for scattering incident light, each scattering centre including one or more surface relief structure elements, and
wherein each gray scale region has a gray scale value determined by the degree of scattering caused by the scattering centres and surface relief structure elements.

2. A security device according to claim 1, wherein each gray scale region is of size 120 micron by 120 micron or less.

3. A security device according to claim 1, wherein the scattering centres and surface relief structure elements of each gray scale region form one or more recognisable images.

4. A security device according to claim 1, wherein the one or more recognisable images formed by the scattering centres and surface relief structure elements of at least one gray scale region are different from the one or more recognisable images formed by the scattering centres and surface relief structure elements of at least another gray scale region.

5. A security device according to claim 1, wherein the plurality of regions are arranged in a regular array.

6. A security device according to claim 1, wherein the one or more recognisable images formed by the scattering centres and surface relief structure elements of at least one gray scale region are the same as the one or more recognisable images formed by the scattering centres and surface relief structure elements of at least another gray scale region.

7. A security device according to claim 1, wherein each gray scale region include one of a limited number of combinations of scattering centres and surface relief structure elements.

8. A security device according to claim 1, wherein the plurality of regions further includes a plurality of diffracting regions such that, upon illumination by the incident light, the device generates one or more diffraction images which are observable from one or more ranges of viewing angles around the device in addition to the macroscopic image.

9. A security device according to claim 8, wherein the gray scale regions provide gray scale enhancement to the diffraction images.
